(19) United States
(12) Patent Application Publication
(10) Pub. No.: US 2026/0087374 A1
(43) Pub. Date: Mar. 26, 2026

(54) EXECUTING QUERIES IN COMPUTING SYSTEMS USING GENERATIVE ARTIFICIAL INTELLIGENCE MODELS AND KEYWORD-BASED PROBLEM SOLVING

(71) Applicant: QUALCOMM Incorporated, San Diego, CA (US)

(72) Inventors: Amr Mamoun MARTINI, San Diego, CA (US); Arvind Vardarajan SANTHANAM, San Diego, CA (US); Swagarika Jaharlal GIRI, San Diego, CA (US); Christopher LOTT, San Diego, CA (US)

(21) Appl. No.: 18/892,024

(22) Filed: Sep. 20, 2024

(51) Int. Cl. G06N 5/01

(52) U.S. Cl. CPC G06N 5/01

(57) ABSTRACT

Certain aspects provide techniques and apparatus for executing queries in a computing system using machine learning models. An example method generally includes receiving a plan to satisfy a request in the computing system and event log data associated with execution of the plan. The plan generally specifies a first plurality of function calls at a first level of granularity. Using a plan refinement machine learning model, a refined plan is generated when the event log data indicates that execution of the generated plan results in one or more execution errors and the one or more execution errors are solvable. Generally, the refined plan specifies a second plurality of function calls at a second level of granularity, the second level of granularity being finer than the first level of granularity.

### INTRODUCTION

Aspects of the present disclosure relate to executing queries in computing systems using generative artificial intelligence models (also referred to as “generative models”or “generative machine learning models”).

Generative artificial intelligence models, such as large language models (LLMs), can be used in artificial intelligence assistants to allow users of such assistants to interact using natural language inputs (e.g., spoken prompts converted from audio to text, textual prompt inputs, etc.). Generally, these artificial intelligence assistants can be used to perform various tasks through different plugins or other tools that interface with these artificial intelligence assistants. These plugins may, for example, allow users to obtain news from various sources (e.g., weather sources, news outlets, equities market data feeds, etc.), schedule events, plan travel, control robots or other household devices, or the like.

### BRIEF SUMMARY

Certain aspects provide a processor-implemented method for executing queries in a computing system using machine learning models. An example method generally includes receiving a query for processing. Using a keyword generation machine learning model and based on the received query, one or more keywords related to the received query are generated. Based on the generated keywords, one or more candidate application programming interface (API) calls for satisfying the received query are identified. A solution is identified based on parameters associated with the received query and the identified one or more candidate API calls, and the identified solution is executed to satisfy the received query.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example of executing a query in a computing system using a generative artificial intelligence model and a problem solver.

FIG. 2 illustrates an example pipeline for executing a query in a computing system based on keywords generated from a received query and parameters extracted from the received query, according to certain aspects of the present disclosure.

FIG. 3 illustrates an example of training a machine learning model to identify a solution for a received query, according to certain aspects of the present disclosure.

FIG. 4 illustrates an example of generating a response to a received query based on a mapping of solver outputs to actions performed by a generative artificial-intelligence-model-based assistant, according to certain aspects of the present disclosure.

FIG. 5 illustrates examples of user profile learning for generating keywords and extracting parameters from a received query for generating a response to the received query, according to certain aspects of the present disclosure.

FIG. 6 illustrates example operations for executing a query in a computing system using keywords generated from a received query and parameters extracted from the received query using machine learning models, according to certain aspects of the present disclosure.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for executing queries in a computing system using generative artificial intelligence models.

Artificial-intelligence-model-based assistants generally allow users to interact with a computing device using natural language inputs in order to execute various tasks on or using the computing device. To do so, an artificial-intelligence-model-based assistant can interface with various software tools that can ingest specific types of information in order to perform specific tasks. For example, an artificial-intelligence-model-based assistant can interface with a first application to respond to requests to add events to a calendar, a second application to respond to requests for the latest news, a third application to respond to requests to book flights or hotel rooms, and the like. These applications generally may be invoked through calling functions exposed by various application programming interfaces (APIs).

Generally, queries input into an artificial-intelligence-model-based assistant request the artificial-intelligence-model-based assistant to perform a specified action. These queries may be broad in scope and involve the execution of multiple functions across different APIs in order to satisfy these queries. Further, the parameters specified in these queries may not be understood as valid parameters by an API. Still further, because of the breadth of user queries that can be processed by an artificial-intelligence-model-based assistant and the breadth of possible parameters specifying a valid response to a query, an artificial-intelligence-model-based assistant may not be able to determine whether it is possible to generate a response that satisfies the query.

Certain aspects of the present disclosure provide techniques for responding to queries using an artificial-intelligence-model-based assistant based on keywords generated from a query and parameters extracted from the query using generative artificial intelligence models. As discussed in further detail herein, queries may be resolved using a solver that identifies API calls to invoke in order to satisfy the request and attempts to maximize the number of parameters satisfied by a candidate response. By using generative artificial intelligence models to identify keywords for use in identifying API calls to execute to satisfy the received query and to extract parameters for these API calls, certain aspects of the present disclosure may rapidly identify a solution (e.g., an API call or sequence of API calls and parameters of those API calls) that maximizes, or at least increases, the number of constraints specified in the query. Such a solution may be identified in fewer iterations than if random search techniques are used to identify a solution that satisfies the constraints identified in a query. Thus, aspects of the present disclosure may allow for artificial-intelligence-model-based assistants to generate responses to a wide variety of queries using fewer computing resources (e.g., processor cycles, memory, time, etc.) and with higher accuracy than techniques in which random search techniques are used to identify a solution that satisfies the constraints identified in a query.

### Example Responding to Queries Using Artificial-Intelligence-Model-Based Assistants and Keyword-Based Solution Generation

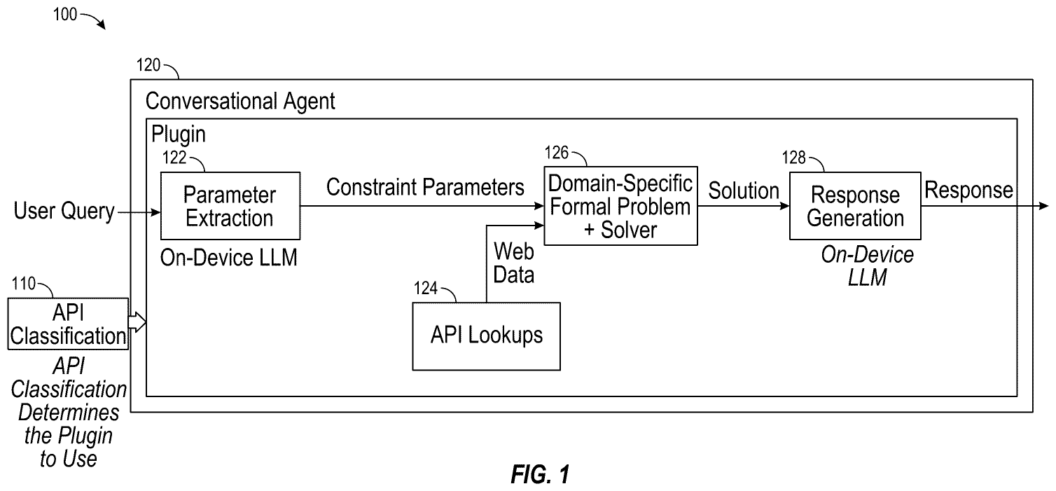

FIG. 1 illustrates an example 100 of executing a query in a computing system using an artificial-intelligence-model-based assistant 120 (labeled “conversational agent”) and a problem solver. Generally, the example 100 illustrates an artificial-intelligence-model-based assistant 120 that allows for complex queries to be processed (e.g., on an edge device on which the artificial-intelligence-model-based assistant 120 is deployed) by parameterizing the query into a formal problem. A formal problem may, for example, be a domain-specific problem, or a problem specific to a data domain in which a query lies. These formal problems may be solved using various techniques, such as satisfiability modulo theory (a technique in which the artificial-intelligence-model-based assistant 120 determines whether a mathematical formula can be solved), Boolean satisfiability (a technique in which the artificial-intelligence-model-based assistant 120 determines whether the output satisfies a defined Boolean (true/false) formula), or the like.

As illustrated, to generate a response to a user query input into the artificial-intelligence-model-based assistant 120, the user query may be input into an API classification block 110 for determining the application(s) which are to be used to satisfy the input query. Generally, the API classification block 110 examines the user query to determine the topic or intent of the query. Different topics or intents may be associated with different applications and corresponding APIs used by the artificial-intelligence-model-based assistant to interface with these applications. For example, a query that requests information about flights to a destination may use various APIs that search flight data repositories (e.g., a global distribution system) for valid flights between an origin point and a destination point on a particular day, while a query that requests information about recipes may use vastly different APIs that search through a repository of recipes for those that satisfy a specific set of parameters (e.g., cuisine type, ingredients, costs, dietary restrictions, etc.).

The API classification generated by the API classification block 110 is generally input into the artificial-intelligence-model-based assistant 120, in conjunction with the user query, for processing. To process the user query, the artificial-intelligence-model-based assistant 120 uses a generative artificial intelligence model to extract parameters from the user query at the parameter extraction block 122. These parameters may include, for example, constraint parameters that define a valid response to the user query. In a scenario in which the user query is a query for the cheapest flight between an origin point and a destination point, for example, these constraint parameters may include a cost parameter, an origin parameter (e.g., an origin airport and optionally other acceptable airports within a specified distance from the origin airport), and a destination parameter (e.g., a destination airport and optionally other acceptable airports within a specified distance from the destination airport). In a scenario in which the user query is for a recipe from a specified type of cuisine and a cost, the constraints may include a type of cuisine parameter and a cost parameter. It should be understood that the foregoing are merely illustrative examples, and the artificial-intelligence-model-based assistant 120 can process any variety of user queries of any variety of topics.

Concurrently or sequentially with the parameter extraction at the parameter extraction block 122, the artificial-intelligence-model-based assistant 120 retrieves data relevant to responding to the user query at the API lookup block 124.

The constraint parameters and retrieved data are then input into the formal problem and solver block 126 for processing. Generally, the formal problem and solver block 126 uses the data retrieved by the API lookup block 124 to populate the parameters of a formal problem defining how the user query can be solved. A solver can examine the various permutations of data retrieved by the API lookup block to identify a solution that results in the generation of a valid response to the input query. Generally, a solution, as discussed, may include the various outputs of executing one or more API calls that satisfies the constraint parameters extracted from the user query by the parameter extraction block 122. The identified solution may be input into a response generation block 128 for further processing. Generally, the response generation block 128 uses a generative artificial intelligence model, such as a large language model (LLM), to generate a textual response to the user query based on the solution identified by the formal problem and solver block 126.

The example 100 illustrates an artificial-intelligence-model-based assistant that allows for the generation of responses to some user queries. However, the artificial-intelligence-model-based assistant may not be effective at producing a solution to a variety of queries. For example, because the universe of options to evaluate for a given query may be large, heuristic or exact solvers used to identify a solution to a formal problem associated with a user query may not be able to effectively evaluate each of the options while remaining responsive. Further, because the applications with which the artificial-intelligence-model-based assistant interfaces may impose limits on the amount of data or the rate at which data is retrieved from these applications, searching through a large universe of possible options may impose significant latencies in generating a response to a user query. In some examples, to address problems related to the size of the universe of potential solutions to a user query, a formal problem for a user query may be divided into multiple sub-problems, and each of these sub-problems may be solved until a solution is identified. However, the solving of sub-problems in order to generate a solution to the overall formal problem associated with a user query may still involve a significant amount of computing resources to execute, as multiple iterations of executing queries may be performed in order to identify a solution that is responsive to the user query.

To improve the computational efficiency involved in responding to user queries using an artificial-intelligence-model-based assistant, as discussed in further detail herein, certain aspects of the present disclosure provide techniques for using parameter extraction and keyword generation techniques to identify a sequence of API calls to execute in order to satisfy a user query. By doing so, certain aspects of the present disclosure can reduce the search space of parameters and API calls that can result in valid responses to a user query (e.g., can truncate the results of the API calls to the subset of API calls that are likely to contain a solution to a formal problem associated with a user query). Thus, an artificial-intelligence-model-based assistant can generate a response using fewer computing resources (e.g., processor cycles, memory, time, etc.) than would be used by performing a random search over a potentially intractable search space to identify a valid response to the user query.

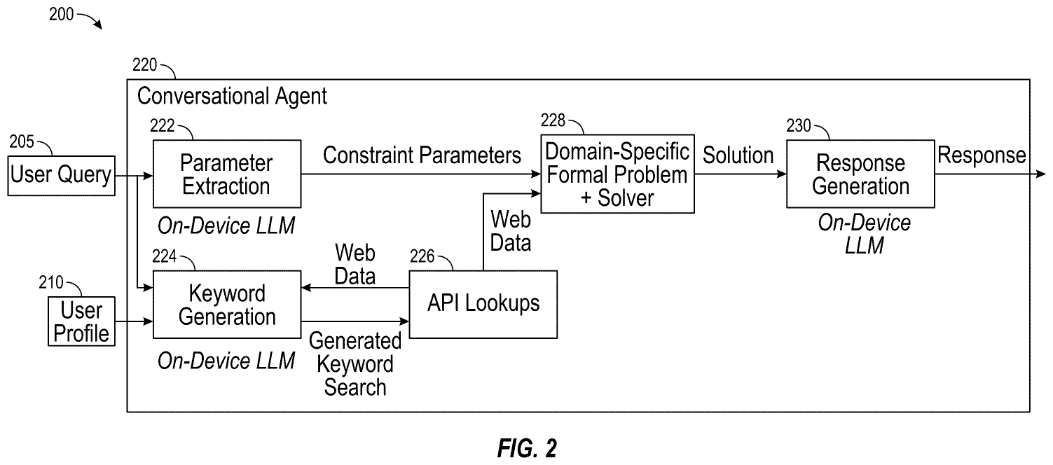

FIG. 2 illustrates an example pipeline 200 for executing a query in a computing system based on keywords generated from a received query and parameters extracted from the received query, according to certain aspects of the present disclosure.

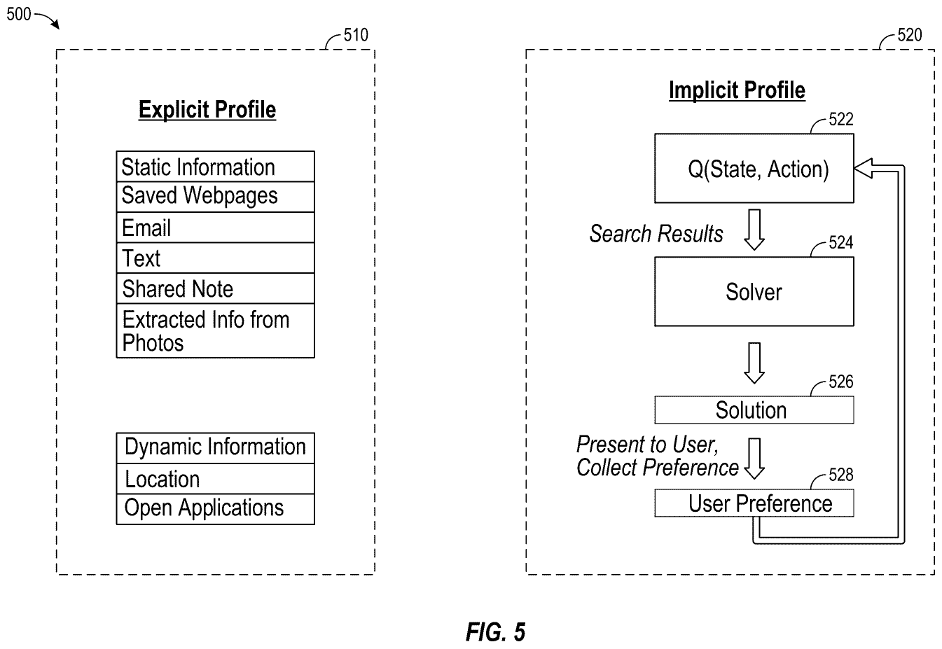

As illustrated, the pipeline 200 may begin with inputting a user query 205 and a user profile 210 into an artificial-intelligence-model-based assistant 220 (labeled “conversational agent”) for processing. Generally, the user query 205 may be a natural language query specifying a result that the user wishes to obtain and the parameters of a valid or desired response to the user query. The user profile 210 may include user information that is statically defined or learned (as discussed in further detail below with respect to FIG. 5) and which can be used to influence the output of a keyword generation block 224.

The user query 205 may be input into a parameter extraction block 222, which, similarly to the parameter extraction block 122 illustrated in FIG. 1, may use a generative artificial intelligence model (such as a large language model) to identify the constraint parameters included in the user query. As discussed, these constraint parameters may define the parameters of a valid response to the user query and may be used as parameters used by a solver to determine whether a formal problem associated with the user query are satisfied by the output of one or more API calls invoked by the artificial-intelligence-model-based assistant 220.

The user query 205 and the user profile 210 may be input into the keyword generation block 224 for generating a set of keywords that can be used to orchestrate the execution of API calls at an API lookups block 226. Generally, the keyword generation block 224 may be a generative artificial intelligence model that is trained to identify various keywords that can identify, for example, data to be retrieved via one or more API calls, the specific API calls to invoke in order to generate a response (or at least a candidate response) to the user query 205, and the like. In some aspects, the user profile 210 may influence the keywords that are generated by the keyword generation block 224; for example, static information such as user favorites, saved webpages, or the like can be used to restrict the universe of keywords generated by the keyword generation block 224 to those which are likely to comply with the user preferences identified in the user profile 210. The keywords generated by the keyword generation block 224 may be output to the API lookups block 226, which may invoke one or more API calls based on the generated keywords to obtain a candidate response to the user query 205. To allow for the generation of additional candidate responses, which may be influenced by the prior candidate responses retrieved from the external applications via the API lookups block 226, the candidate response may be returned to the keyword generation block 224. Further, the candidate response may be output from the API lookups block 226 to a formal problem and solver block 228 for processing.

Generally, the generation of keywords for performing API calls by the keyword generation block 224 may include, for example, the generation of input parameters to various API calls that can be invoked by the API lookups block 226 to generate candidate responses to the user query 205. Each of the candidate responses can be evaluated to identify a solution—the results of executing an API call with a specific set of input keywords—that maximizes, or at least increases, the number of constraint parameters satisfied by the solution.

The formal problem and solver block 228, similar to the formal problem and solver block 126 illustrated in FIG. 1, may use the constraint parameters extracted from the user query 205 to define a formal problem that the solver attempts to satisfy based on the candidate responses generated by invoking API calls with specified keywords at the API lookups block 226. The solver may examine the various permutations of data retrieved by the API lookup block to identify a solution that results in the generation of a valid response to the input query, which, as discussed, may attempt to maximize the number of constraint parameters satisfied by a candidate response. From the universe of candidate responses generated by the API lookups block 226, the candidate response that satisfies the greatest number of constraint parameters may be deemed the solution and may be output to a response generation block 230 for further processing. Generally, the response generation block 230, similar to the response generation block 128 illustrated in FIG. 1, may transform, using a generative artificial intelligence model such as a large language model, the candidate response selected as the solution to the user query 205 into a natural language output that is responsive to the user query 205.

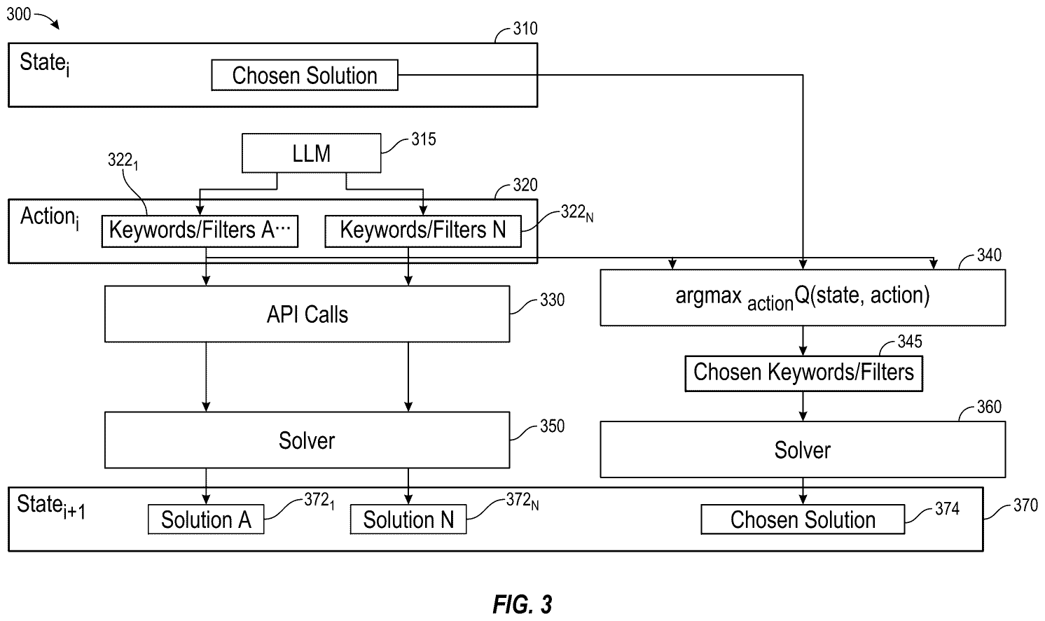

In some aspects, the artificial-intelligence-model-based assistant 220 can generate responses to a user query 205 using a machine learning model trained using a Monte Carlo tree search technique, as illustrated in FIG. 3. In the example 300, at a first state 310, a solution to a user query may be selected for potential refinement. Generally, such a solution may be a solution that satisfies at least some constraint parameters defined in the user query. In an action block 320, a generative artificial intelligence model (e.g., deployed at the keyword generation block 224 illustrated in FIG. 2) may generate a plurality of keyword sets 322₁ through 322_{N}, each of which may correspond to a different set of search keywords which may be input into one or more API calls to generate a potential solution to the user query.

The keyword sets 322₁ through 322_{N} may be used by an API lookups block (e.g., the API lookups block 226 illustrated in FIG. 2) to perform API calls 330 that result in the generation of various potential solutions to the user query. The results of performing the API calls 330 may be fed into a solver 350, which, as discussed above with respect to the formal problem and solver block 228 illustrated in FIG. 2, may evaluate the results to determine whether the results solve the formal problem associated with the user query. If so, these results may be deemed potential solutions 372₁ through 372_{N} at a next state 370.

As illustrated, the keyword sets 322₁ through 322_{N} may also be input, along with the chosen solution at state 310, to a reward function Q 340 for processing. Generally, the reward function Q 340 may identify the state and action, based on the chosen solution at state 310 and the keyword sets 322₂ through 322_{N}, to choose a set of keywords 345 that maximizes (or at least increases) a reward corresponding to a likelihood that set of keywords 345 results in a response that maximizes (or at least increases) the number of constraints satisfied by the response. The set of keywords 345 may be input into a solver 360, which may evaluate the results generated by executing one or more API calls based on the chosen solution at state 310 and the chosen keywords to determine the chosen solution. The value of the reward function Q 340 may be backpropagated through the machine learning model to train the model to generate responses that maximize, or at least increase, the number of constraint parameters that are satisfied.

In an illustrative example, suppose that a model is used to identify keywords for API calls related to generating a recipe that satisfies a set of constraints (e.g., types of ingredients, number of servings, delivery time, price, etc.). To train such a model from an empty state, keyword sets A and B may be generated, and a first set of actions may be performed based on the keyword sets A and B. The results of executing the first set of actions may be evaluated by the formal problem and solver block 228, and based on the number of constraints satisfied by the results of executing the first set of actions, one of the keyword sets A or B may be selected for refinement. Suppose that keyword set A satisfies more constraints than keyword set B. Thus, the keyword set A may be modified into a keyword set A′, a new set of keywords C may be generated, and a second set of actions may be performed based on the keyword sets A′ and B. The results of executing the second set of actions may be evaluated by the formal problem and solver block 228, and additional permutations and filters of keywords may be generated and used until a specified number of rounds of inferencing are performed. At the final round of inferencing, a reward metric may be calculated for the solution that satisfies the greatest number of constraints, and the reward metric may be backpropagated through the model.

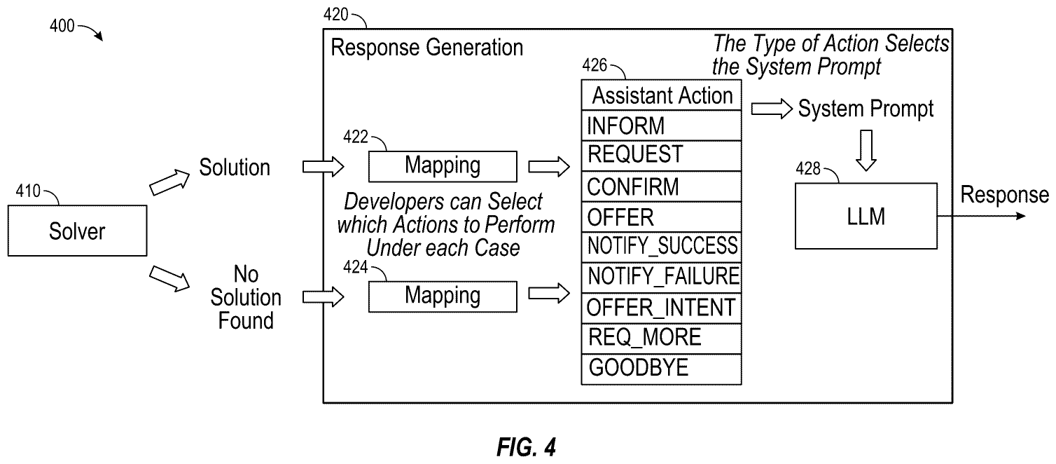

FIG. 4 illustrates an example 400 of generating a response to a received query based on a mapping of solver outputs to actions performed by a generative artificial-intelligence-model-based assistant, according to certain aspects of the present disclosure.

As illustrated, in the example 400, a solver 410 may generate a binary classification for the set of candidate responses generated for a user query. The binary classification may specify whether a candidate response is a solution to the user query or if no candidate response is a solution to the user query. The response generation block 420 (which may correspond to the response generation block 230 illustrated in FIG. 2) can use a priori defined mappings 422 where a candidate response is a solution to the user query and mappings 424 where no candidate response is a solution to the user query to identify an action to perform. Generally, these mappings 422 and 424 may map the identification of a solution or the failure to identify a solution to an action from a set of actions 426 that an artificial-intelligence-model-based assistant can perform. The action may correspond to a specific system prompt that a generative artificial intelligence model 428 (labeled “LLM”) can use to generate a natural language response based on the output of the solver 410 and (where a solution has been found to the user query) the candidate response selected as the solution (e.g., the candidate response that maximizes the number of satisfied constraints from the set of constraints extracted from the user query).

FIG. 5 illustrates examples 500 of user profile learning for generating keywords and extracting parameters from a received query for generating a response to the received query, according to certain aspects of the present disclosure.

As illustrated, user profile learning may be based on an explicit profile 510 and/or an implicit profile 520. Generally, an explicit profile 510 may include information that is defined by a user or can be derived from user activity on a device on which an artificial-intelligence-model-based assistant executes. For example, the explicit profile 510 may be generated based on static information, such as content saved on the device, as well as dynamic information, such as the location of the device (as a device such as a mobile phone may generate inferences or be requested to perform different types of actions in different places), the applications that are open or with which a user has interacted within a time window, or the like. This explicit profile 510 may, as discussed above, be used to influence the keywords generated by a keyword generator and used as parameters for invoking one or more API calls that generate candidate responses to a user query. To use a travel example, information such as a saved frequent traveler account, previously issued tickets included in emails or other communications stored on the device, and the like may be used to generate keywords that result in the generation of results that comply with the preferences embodied in the saved frequent traveler account and previously issued tickets (e.g., the carriers for which travel itineraries are identified, the class of service, etc.).

An implicit profile 520, however, may be generated based on the presentation of candidate responses to the user of the artificial-intelligence-model-based assistant. As illustrated, the implicit profile 520 may be generated based the output of a reward function 522 (which, as discussed above, attempts to identify the solution to a user query that maximizes the number of constraint parameters satisfied by the output of API calls for a given set of keywords). The solution identified by the reward function 522 may be processed by the solver 524 to determine whether the solution identified by the reward function 522 solves the formal problem associated with the user query. If so, the solution identified by the reward function 522 may be deemed the solution 526 and output to a user for review. User preference information 528 may be derived from the user's response to the solution 526 and used, using direct preference optimization, to refine the reward function 522. If the user rejects the solution 526 or changes the solution 526, the information about the rejection or the changes may be used to refine the reward function 522 so that the reward function 522 learns to not generate a response with similar features as the solution 526. Likewise, if the user accepts the solution 526, the information about user acceptance may be used to reinforce the training of the reward function 522 so that solutions similar to the solution 526 are output to the user.

By generating keywords from a user query and using these keywords (and permutations thereof) to identify candidate solutions to the user query, aspects of the present disclosure may reduce the search space over which solutions to a user query are evaluated. The generation of keywords specific to a user query may allow for an artificial-intelligence-model-based assistant to truncate or filter the universe of data over which potential solutions to the user query lie intelligently, rather than performing random truncations that may not reduce the search space to a space in which a solution to a formal problem associated with the user query lies. Further, aspects of the present disclosure may allow for targeted execution of API calls instead of blanket API calls that result in attempts to “scrape” data from a large data repository. Thus, aspects of the present disclosure may reduce the computational expense involved in generating an execution plan for generating a response to a user query, as fewer external API calls may be invoked, and fewer iterations of refining or changing input parameters or other keywords may be involved in identifying a solution to a user query.

### Example Operations for Responding to Queries Using Artificial-intelligence-Model-Based Assistants and Keyword-Based Solution Generation

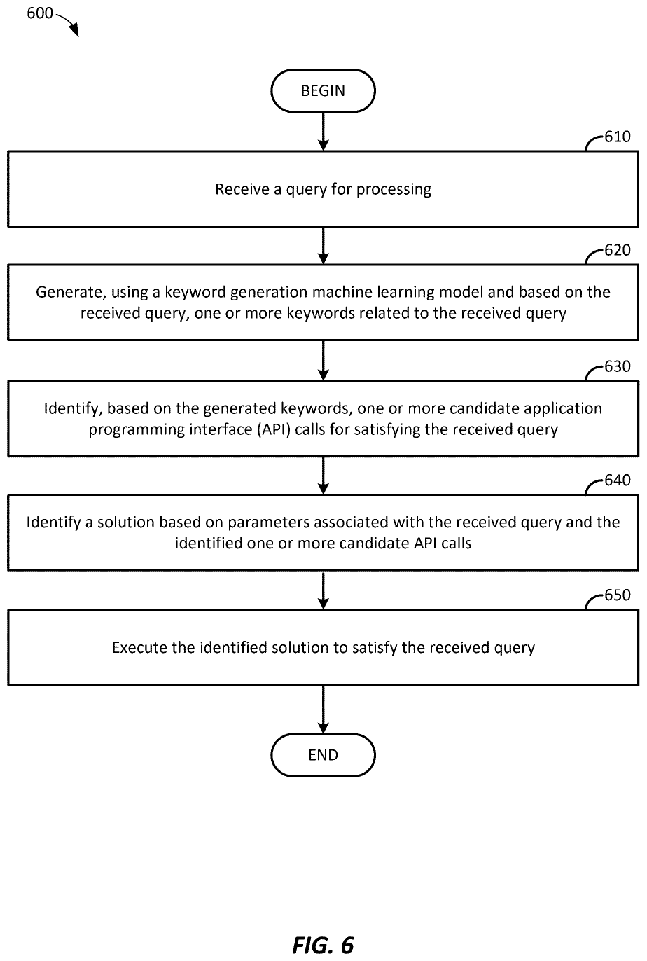

FIG. 6 illustrates example operations 600 for executing a query in a computing system using keywords generated from a received query and parameters extracted from the received query using machine learning models, according to certain aspects of the present disclosure.

As illustrated, the operations 600 begin at block 610, with receiving a query for processing.

At block 620, the operations 600 proceed with generating, using a keyword generation machine learning model and based on the received query, one or more keywords related to the received query.

At block 630, the operations 600 proceed with identifying, based on the generated keywords, one or more candidate application programming interface (API) calls for satisfying the received query.

At block 640, the operations 600 proceed with identifying a solution based on parameters associated with the received query and the identified one or more candidate API calls. The solution may be identified, for example, based on identifying a formal problem associated with the query and a solver configured to solve the formal problem. As discussed above, the parameters associated with the received query may define a formal problem that the solver attempts to satisfy based on the candidate responses generated by invoking API calls with specified keywords.

At block 650, the operations 600 proceed with executing the identified solution to satisfy the received query.

In some aspects, the identified solution includes a set of API calls from the one or more candidate API calls and a sequence in which API calls in the set of API calls are to be invoked.

In some aspects, the identified solution includes a set of API calls and input parameters for each API call in the set of API calls.

In some aspects, the keyword generation machine learning model comprises a Monte Carlo tree model trained based on maximizing (or at least increasing) a number of constraints derived from the query that are satisfied by an output of the Monte Carlo tree model.

In some aspects, the parameters may be extracted from the received query using a machine learning model. The machine learning model may be, for example, a generative artificial intelligence model, such as a large language model, that can generate these parameters based on the received query and an input prompt that instructs the generative artificial intelligence model to extract parameters defining the conditions which are to be satisfied by a solution identified for the received query.

In some aspects, identifying the solution comprises identifying actions executable by a generative-artificial-intelligence-model-based assistant based on a mapping of each of a plurality of solutions to corresponding actions executable by the generative-artificial-intelligence-model-based assistant.

In some aspects, the operations 600 further include receiving user feedback relating to the identified solution for satisfying the received query and refining the keyword generation machine learning model based on the received user feedback.

In some aspects, the operations 600 further include refining the keyword generation machine learning model based on user profile information. The user profile information may include at least one of static information derived from user data or dynamic information derived from state information associated with the computing system. The state information may include, for example, the location of the computing system, open applications or recently used applications on the computing system, and the like.

In some aspects, the keyword generation machine learning model comprises a local generative machine learning model executing on the device on which a request is received.

In some aspects, the operations 600 further include refining the keyword generation machine learning model based on results of executing API calls for different sets of keywords generated by the keyword generation machine learning model.

### Example Systems for Responding to Queries Using Artificial-Intelligence-Model-Based Assistants and Keyword-Based Solution Generation

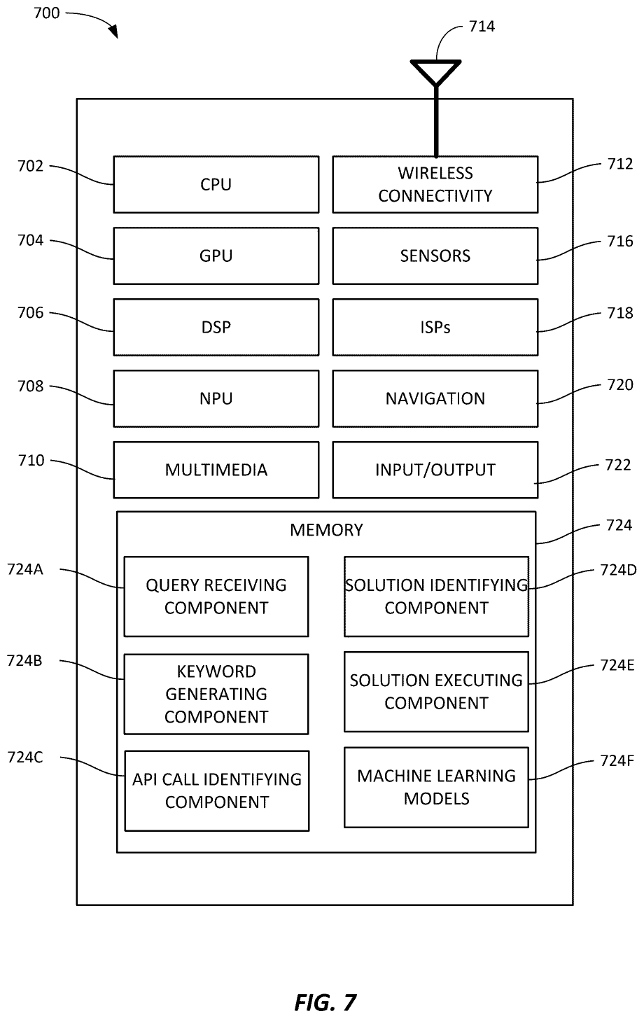

FIG. 7 depicts an example processing system 700 configured to perform various aspects of the present disclosure, including, for example, the techniques and methods described with respect to FIGS. 2-5. In some aspects, the processing system 700 may train, implement, or provide a machine learning model which uses quantized data to accelerate operations and perform machine learning model operations using less power than would be used if such operations were performed using non-quantized data. Although depicted as a single system for conceptual clarity, in at least some aspects, as discussed above, the operations described below with respect to the processing system 700 may be distributed across any number of devices.

The processing system 700 includes a central processing unit (CPU) 702, which in some examples may be a multi-core CPU. Instructions executed at the CPU 702 may be loaded, for example, from a program memory associated with the CPU 702 or may be loaded from a partition of memory 724.

The processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation component 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes the memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes query receiving component 724A, a keyword generating component 724B, an API call identifying component 724C, a solution identifying component 724D, a solution executing component 724E, and machine learning models 724F. Though depicted as discrete components for conceptual clarity in FIG. 7, the illustrated components (and others not depicted) may be collectively or individually implemented in various aspects.

Generally, the processing system 700 and/or components thereof may be configured to perform the methods described herein.

Notably, in other aspects, aspects of the processing system 700 may be omitted, such as where the processing system 700 is a server computer or the like. For example, the multimedia processing unit 710, the wireless connectivity component 712, the sensor processing units 716, the ISPs 718, and/or the navigation component 720 may be omitted in other aspects. Further, aspects of the processing system 700 may be distributed between multiple devices.

### Example Clauses

Implementation details of various aspects of the present disclosure are described in the following numbered clauses:

Clause 1: A processor-implemented method for executing queries on a device using machine learning models, comprising: receiving a query for processing; generating, using a keyword generation machine learning model and based on the received query, one or more keywords related to the received query; identifying, based on the generated keywords, one or more candidate application programming interface (API) calls for satisfying the received query; identifying a solution based on parameters associated with the received query and the identified one or more candidate API calls; and executing the identified solution to satisfy the received query.

Clause 2: The method of Clause 1, wherein the identified solution includes a set of API calls from the one or more candidate API calls and a sequence in which API calls in the set of API calls are to be invoked.

Clause 3: The method of Clause 1 or 2, wherein the identified solution includes a set of API calls and input parameters for each API call in the set of API calls.

Clause 4: The method of any of Clauses 1 through 3, wherein the keyword generation machine learning model comprises a Monte Carlo tree model trained based on maximizing a number of constraints derived from the query that are satisfied by an output of the Monte Carlo tree model.

Clause 5: The method of any of Clauses 1 through 4, wherein identifying the solution comprises identifying actions executable by a generative-artificial-intelligence-model-based assistant based on a mapping of each of a plurality of solutions to corresponding actions executable by the generative-artificial-intelligence-model-based assistant.

Clause 6: The method of any of Clauses 1 through 5, further comprising: receiving user feedback relating to the identified solution for satisfying the received query; and refining the keyword generation machine learning model based on the received user feedback.

Clause 7: The method of any of Clauses 1 through 6, further comprising refining the keyword generation machine learning model based on user profile information.

Clause 8: The method of Clause 7, wherein the user profile information comprises at least one of static information derived from user data or dynamic information derived from state information associated with the computing system.

Clause 9: The method of any of Clauses 1 through 8, wherein the keyword generation machine learning model comprises a local generative machine learning model executing on the device.

Clause 10: The method of any of Clauses 1 through 9, further comprising refining the keyword generation machine learning model based on results of executing API calls for different sets of keywords generated by the keyword generation machine learning model.

Clause 11: A processing system comprising: at least one memory comprising computer-executable instructions; and one or more processors configured to execute the computer-executable instructions and cause the processing system to perform a method in accordance with any of Clauses 1 through 10.

Clause 12: A processing system comprising means for performing a method in accordance with any of Clauses 1 through 10.

Clause 13: A non-transitory computer-readable medium comprising computer-executable instructions that, when executed by one or more processors of a processing system, cause the processing system to perform a method in accordance with any of Clauses 1 through 10.

Clause 14: A computer program product embodied on a computer-readable storage medium comprising code for performing a method in accordance with any of Clauses 1 through 10.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration. ” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining”may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S. C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system for executing queries on a device using machine learning models, comprising:
at least one memory having executable instructions stored thereon; and
one or more processors configured to execute the executable instructions to cause the processing system to:
receive a query for processing;
generate, using a keyword generation machine learning model and based on the received query, one or more keywords related to the received query;
identify, based on the generated keywords, one or more candidate application programming interface (API) calls for satisfying the received query;
identify a solution based on parameters associated with the received query and the identified one or more candidate API calls; and
execute the identified solution to satisfy the received query.

2. The processing system of claim 1, wherein the identified solution includes a set of API calls from the one or more candidate API calls and a sequence in which API calls in the set of API calls are to be invoked.

3. The processing system of claim 1, wherein the identified solution includes a set of API calls and input parameters for each API call in the set of API calls.

4. The processing system of claim 1, wherein the keyword generation machine learning model comprises a Monte Carlo tree model trained based on maximizing a number of constraints derived from the query that are satisfied by an output of the Monte Carlo tree model.

5. The processing system of claim 1, wherein to identify the solution, the one or more processors are configured to cause the processing system to identify actions executable by a generative-artificial-intelligence-model-based assistant based on a mapping of each of a plurality of solutions to corresponding actions executable by the generative-artificial-intelligence-model-based assistant.

6. The processing system of claim 1, wherein the one or more processors are further configured to cause the processing system to:
receive user feedback relating to the identified solution for satisfying the received query; and
refine the keyword generation machine learning model based on the received user feedback.

7. The processing system of claim 1, wherein the one or more processors are further configured to cause the processing system to refine the keyword generation machine learning model based on user profile information.

8. The processing system of claim 7, wherein the user profile information comprises at least one of static information derived from user data or dynamic information derived from state information associated with a computing system.

9. The processing system of claim 1, wherein the keyword generation machine learning model comprises a local generative machine learning model executing on the device.

10. The processing system of claim 1, wherein the one or more processors are further configured to cause the processing system to refine the keyword generation machine learning model based on results of executing API calls for different sets of keywords generated by the keyword generation machine learning model.

11. A processor-implemented method for executing queries on a device using machine learning models, comprising:
receiving a query for processing;
generating, using a keyword generation machine learning model and based on the received query, one or more keywords related to the received query;
identifying, based on the generated keywords, one or more candidate application programming interface (API) calls for satisfying the received query;
identifying a solution based on parameters associated with the received query and the identified one or more candidate API calls; and
executing the identified solution to satisfy the received query.

12. The method of claim 11, wherein the identified solution includes a set of API calls from the one or more candidate API calls and a sequence in which API calls in the set of API calls are to be invoked.

13. The method of claim 11, wherein the identified solution includes a set of API calls and input parameters for each API call in the set of API calls.

14. The method of claim 11, wherein the keyword generation machine learning model comprises a Monte Carlo tree model trained based on maximizing a number of constraints derived from the query that are satisfied by an output of the Monte Carlo tree model.

15. The method of claim 11, wherein identifying the solution comprises identifying actions executable by a generative-artificial-intelligence-model-based assistant based on a mapping of each of a plurality of solutions to corresponding actions executable by the generative-artificial-intelligence-model-based assistant.

16. The method of claim 11, further comprising:
receiving user feedback relating to the identified solution for satisfying the received query; and
refining the keyword generation machine learning model based on the received user feedback.

17. The method of claim 11, further comprising refining the keyword generation machine learning model based on user profile information.

18. The method of claim 17, wherein the user profile information comprises at least one of static information derived from user data or dynamic information derived from state information associated with a computing system.

19. The method of claim 11, further comprising refining the keyword generation machine learning model based on results of executing API calls for different sets of keywords generated by the keyword generation machine learning model.

20. A non-transitory computer-readable medium having executable instructions stored thereon which, when executed by one or more processors, performs an operation for executing queries on a device using machine learning models, the operation comprising:
receiving a query for processing;
generating, using a keyword generation machine learning model and based on the received query, one or more keywords related to the received query;
identifying, based on the generated keywords, one or more candidate application programming interface (API) calls for satisfying the received query;
identifying a solution based on parameters associated with the received query and the identified one or more candidate API calls; and
executing the identified solution to satisfy the received query.
